(19) United States
(12) Patent Application Publication
(10) Pub. No.: US 2022/0192080 A1
(43) Pub. Date: Jun. 23, 2022

(54) DEVICES, SYSTEMS, AND METHODS FOR SEED DELIVERY CONTROL

(71) Applicant: Ag Leader Technology, Ames, IA (US)

(72) Inventors: Darin Goza, Ames, IA (US); Richard K. Kaufman, Ames, IA (US)

(21) Appl. No.: 17/556,506

(22) Filed: Dec. 20, 2021

Related U.S. Application Data
(60) Provisional application No. 63/127,598, filed on Dec. 18, 2020.

(51) Int. Cl. A01C 7/10; A01C 7/20

(52) U.S. Cl. CPC A01C 7/102; A01C 7/20

(57) ABSTRACT

A seed delivery system including a seed meter, a flighted belt configured to accept seed from the seed meter, transport seeds to an ejection location, and eject seeds into a seed trench, and a controller in communication with the flighted belt configured to control the speed of the flighted belt, wherein the controller is configured to dynamically adjust the speed of the flighted belt.

### CROSS-REFERENCE TO RELATED APPLICATION(S)

This application claims the benefit under 35 U.S.C. § 119(e) to U.S. Provisional Application 63/127,598, filed Dec. 18, 2020, and entitled “Devices, Systems, and Method for Seed Delivery Control,” which is hereby incorporated herein by reference in its entirety for all purposes.

### TECHNICAL FIELD

The disclosure relates to agricultural planters and generally to seed delivery devices, systems, and methods.

### BACKGROUND

As agricultural planting technologies continue to improve high-speed, precision agriculture is fast becoming the industry standard. Under these high-speed parameters, agricultural planters are required to place seeds in the ground with precise and repeatable spacing between the seeds in order to maximize crop health and yield. This seed spacing must be maintained at any ground speed.

Various seed delivery systems having flighted belts are known in the art. With these prior known systems controlling the delivery tube to equal ground speed has limitations since the flighted belt delivery systems have discrete flights and therefore seeds cannot be placed at infinite locations on the belt. There is a need in the art for improved systems, methods, and devices for accurately planting seeds for use with high-speed planting implements.

### BRIEF SUMMARY

Disclosed herein are various systems, methods, and devices for the control of the speed of a flighted belt or other delivery mechanism within a delivery tube of a high-speed planting system.

In Example 1, a method for delivering seeds to a seed trench comprising determining an ideal number of flights per seed and adjusting a speed of a flighted belt such that the ideal number of flights per seed is an integer, wherein the speed of the flighted belt is adjusted such that ejection speed of the seed is approximately equal to ground speed of a planter.

In Example 2, the method of Example 1, further comprising determining a nearest larger integer and nearest smaller integer for the ideal number of flights per seed.

In Example 3, the method of any of Examples 1-2, further comprising reducing the speed of the flighted belt when the ideal number of flight per seed is closer to the nearest smaller integer than the nearest larger integer.

In Example 4, the method of any of Examples 1-3, wherein the reduction of speed of the flighted belt is equal to

$$groundspeed * \frac{nearestsmallerinteger}{{idealspacing}_{flights \text{/} seed}} .$$

In Example 5, the method of any of Examples 1-4, further comprising increasing the speed of the flighted belt when the ideal number of flights per seed is closer to the nearest larger integer than the nearest small integer.

In Example 6, the method of any of Examples 1-5, wherein the increase of speed of the flighted belt is equal to

$$groundspeed * \frac{nearestlargerinteger}{{idealspacing}_{flights \text{/} seed}} .$$

In Example 7, the method of any of Examples 1-6, further comprising inputting one or more of a flight tip diameter, a pulley diameter, and a row spacing.

In Example 8, the method of any of Examples 1-7, further comprising determining a ground speed of the planter.

In Example 9, the method of any of Examples 1-8, wherein the ideal number of flights per seed is equal to

$$targetseedspacing * \frac{{diameter}_{pulley}}{{diameter}_{flighttip}} .$$

In Example 10, a seed delivery system, comprising: a seed meter; a flighted belt configured to accept seed from the seed meter, transport seeds to an ejection location, and eject seeds into a seed trench; and a controller in communication with the flighted belt configured to control the speed of the flighted belt, wherein the controller is configured to dynamically adjust the speed of the flighted belt.

In Example 11, the system of Example 10, wherein the speed of the flighted belt is adjusted as a percentage of ground speed.

In Example 12, the system of any of Examples 10-11, wherein the controller is configured to determine an ideal number of flights per seed.

In Example 13, the system of any of Examples 10-12, wherein the controller compares the ideal number of flights per seed to a next larger integer and a next smaller integer, and wherein the controller adjusts the speed of the flighted belt such that the number of flights per seed is equal to either the next larger integer or the next smaller integer whichever is closer to the ideal number of flights per seed.

In Example 14, the system of any of Examples 10-13, wherein the flighted belt paces around at least one pulley, wherein the ratio of a diameter of the pulley to a diameter at a tip of a flight of the flighted belt multiplied by a target seed spacing is equal to the ideal number of flights per seed.

In Example 15, the system of any of Examples 10-14, wherein the speed of the flighted belt causes the seed to be ejected into the seed trench at approximately the forward travel speed of a planter.

In Example 16, a method for dynamically adjusted speed of a seed delivery belt, comprising: receiving by the seed delivery belt seed from a seed meter, the seed delivery belt comprising discretely placed flights; and adjusting a speed of the seed delivery belt to deliver seeds to a seed trench at a target seed spacing.

In Example 17, the method of Example 16, further comprising determining an ideal number of flights per seed.

In Example 18, the method of any of Examples 16-17, further comprising: determining the nearest larger integer to the ideal number of flights per seed, determining the nearest smaller integer to the ideal number of flights per seed, calculating a speed up ratio equal to

$$\frac{nearestlargerinteger}{{idealspacing}_{flights \text{/} seed}} ,$$

calculating a slow down ratio equal to

$$\frac{nearestsmallerinteger}{{idealspacing}_{flights \text{/} seed}} ,$$

determining if the speed up ratio or the slow down ratio is closer to one, and slowing down the seed delivery belt if the slow down ratio is closer to one or speeding up the seed delivery belt if the speed up ratio is closer to one.

In Example 19, the method of any of Examples 16-18, wherein the speed of the seed delivery belt is adjusted to equal groundspeed*speedupratio if the seed delivery belt is to be sped up and is adjusted to equal groundspeed*slowdownratio if the seed delivery belt is to be slowed down.

In Example 20, the method of any of Examples 16-19, wherein the method is performed iteratively.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a graph showing seed placement when belt speed is set to match seed spacing, according to one example.

FIG. 2 is a graph showing the coefficient of variance for various populations of seed when a belt speed is set to match seed spacing, according to one example.

FIG. 3A is a graph showing the coefficient of variance for seed spacing when the population of seeds is set to 100,000 seeds per acre and the belt speed is adjusted as a percentage of ground speed, according to one implementation.

FIG. 3B is a graph showing the coefficient of variance for seed spacing when the population of seeds is set to 140,000 seeds per acre and the belt speed is adjusted as a percentage of ground speed, according to one implementation.

FIG. 4A is a perspective view of a planter, according to one implementation.

FIG. 4B is a perspective view of a row unit, according to one implementation.

FIG. 4C is a side view of a seed metering and delivery system, according to one implementation.

FIG. 4D is a cross sectional view of a seed tube and delivery system, according to one implementation.

FIG. 4E is a schematic view of the speed adjustment system, according to one implementation.

FIG. 5 is a flow diagram of the speed adjustment algorithm, according to one implementation.

FIG. 6A is a graph showing the distribution of seeds when belt speed matches ground speed, according to one implementation.

FIG. 6B is a graph showing the distribution of seed when belt speed is adjusted as a percentage of ground speed, according to one implementation.

FIG. 7A is a graph showing the distribution of seeds when belt speed matches ground speed, according to one implementation.

FIG. 7B is a graph showing the distribution of seed when belt speed is adjusted as a percentage of ground speed, according to one implementation.

FIG. 8A is a graph showing the distribution of seeds when belt speed matches ground speed, according to one implementation.

FIG. 8B is a graph showing the distribution of seed when belt speed is adjusted as a percentage of ground speed, according to one implementation.

FIG. 9A is a graph showing the distribution of seeds when belt speed matches ground speed, according to one implementation.

FIG. 9B is a graph showing the distribution of seed when belt speed is adjusted as a percentage of ground speed, according to one implementation.

### DETAILED DESCRIPTION

Various implementations disclosed and contemplated herein relate generally to systems, methods, and devices for the control of certain components of various high speed planting systems, such as but not limited to those within a delivery tube. In certain implementations, the disclosed approaches utilize a target seed spacing and determine a delivery tube belt speed that is close to ground speed in order to improve actual seed spacing and overall planting outcomes. As would be appreciated, consistent seed spacing improves overall yields by maximizing the number of plants in an area while maintaining adequate space between plants for growth and health.

The disclosed technology compensates for the fact that in known systems having a flighted belt, the discrete flight spacing limits the precision of seed placement along the belt and ultimately on the ground. In various implementations, an algorithm is utilized to make adjustments to the delivery tube belt speed in order to improve in-field seed spacing while still using a flighted belt. It is understood that the various seed control implementations disclosed or contemplated herein can be incorporated into any known planting or seeding machine, such as, but not limited to, row crop planters, grain drills, air seeders, etc.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. patent application Ser. No. 16/272,590, filed Feb. 11, 2019, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 11, 2019, entitled “On-The-Go Organic Matter Sensor and Associated Systems and Methods,” U.S. patent application Ser. No. 16/752,989, filed Jan. 27, 2020, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/323,649, filed May 18, 2021, entitled “Assisted Steering Apparatus and Associated Systems and Methods,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/526,947, filed Nov. 15, 2021, entitled “Agricultural High Speed Row Unit,” U.S. Patent Application 63/137,946, filed Jan. 15, 2021, entitled “Apparatus, Systems, and Methods for Row Crop Headers,” U.S. Patent Application 63/176,408, filed Apr. 19, 2021, entitled “Automatic Steering Systems and Methods,” U.S. Patent Application 63/186,995, filed May 11, 2021, entitled “Calibration Adjustment for Automatic Steering Systems,” and U.S. Patent Application 63/289,456, filed Dec. 14, 2021, entitled “Seed Tube Guard,” each of which is incorporated herein by reference.

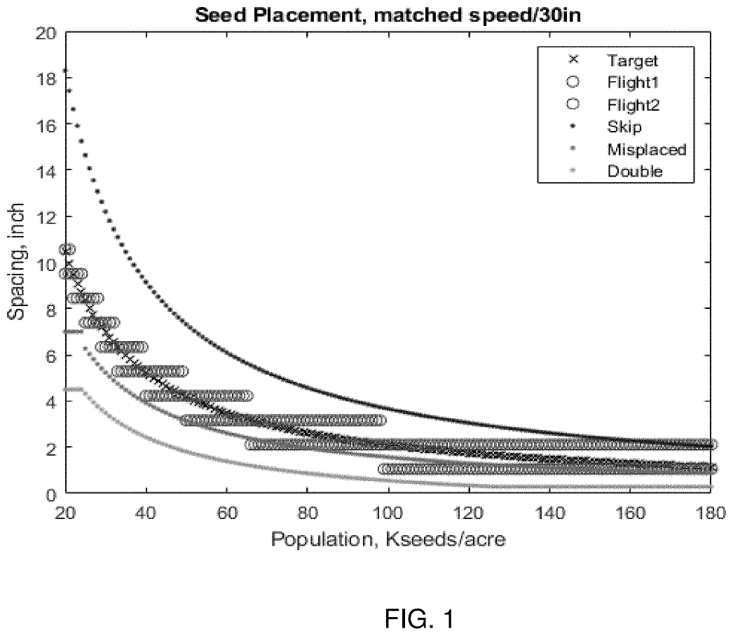

It is understood that differences in the rate that seeds are supplied by the meter and the flight spacing results in seeds being placed in a seed trench at distances that differ from the target seed placement as shown in FIG. 1. This variance in actual seed spacing from the target seed spacing can result in decreased use of flighted belts as a component of planters, due to a number of effects, such as decreased yields and overall plant health. For example, if crops are planted too close together the crops may compete for resources (nutrients, water, sunlight) leading to a decrease in yield for one or both plants. Further shortcomings of poor seed spacing will be appreciated. Certain planters may utilize brush belts as alternative to flighted belts, but these belts are known to hang on to seeds, not releasing them properly, or at all, also causing poor seed spacing.

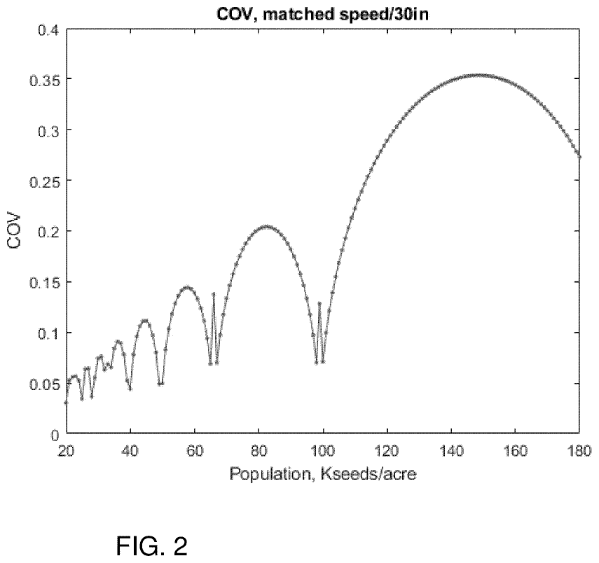

FIG. 2 shows the variance in seed spacing that can result from the of use of a flighted belt and matching the flight speed to ground speed. As is shown, the amount of variance is dependent upon population and row spacing when flight speed is set to match ground speed. As is understood in the art, it is desirable to match flight speed to ground speed to prevent rolling of the seed after exit of the seed from the delivery tube.

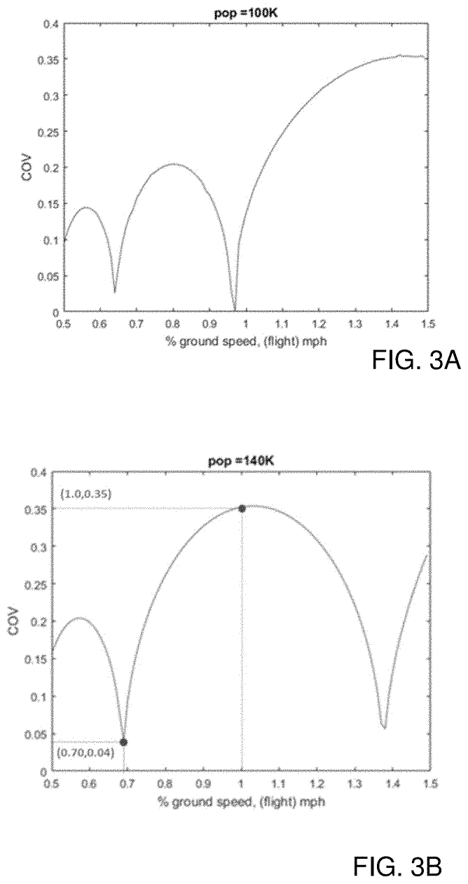

Turning now to FIGS. 3A and 3B, when the flight speed is adjusted as a percentage of ground speed, as discussed further herein, the coefficient of variance (COV) of seed spacing can be reduced, resulting in more consistently spaced seeds throughout the field. A more consistently spaced field can lead to improved yields and crop health. As would be appreciated, crops should be spaced at particular distances from each other to reduce competition for resources. By maintaining proper spacing the crops are more likely to experience even growth and increased overall yields.

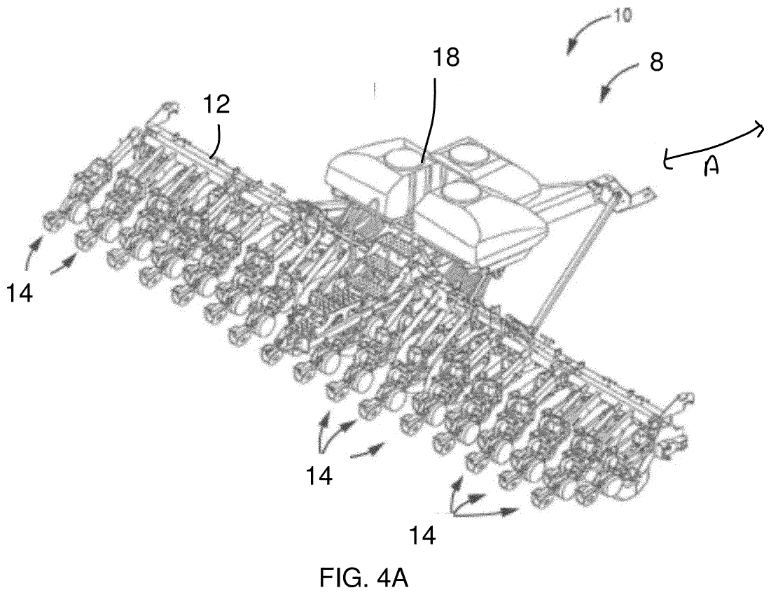

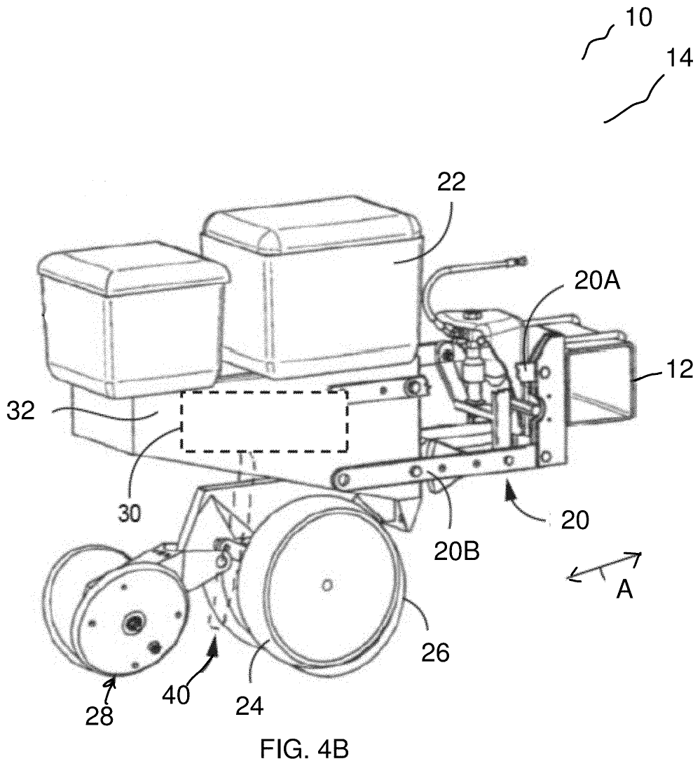

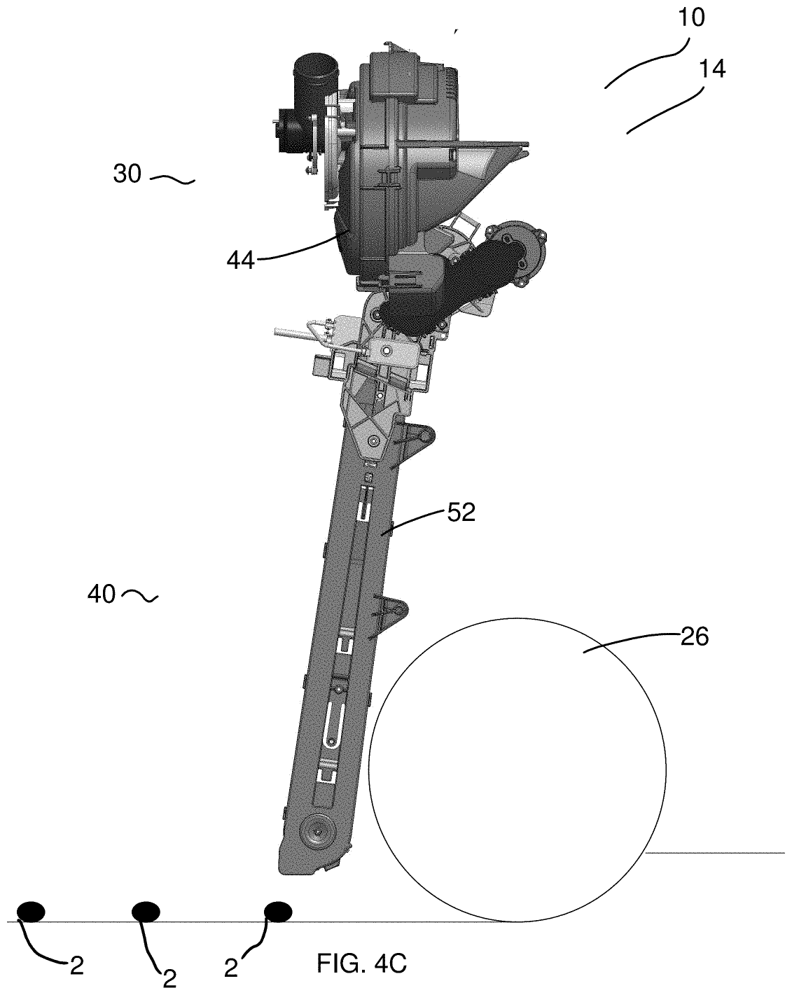

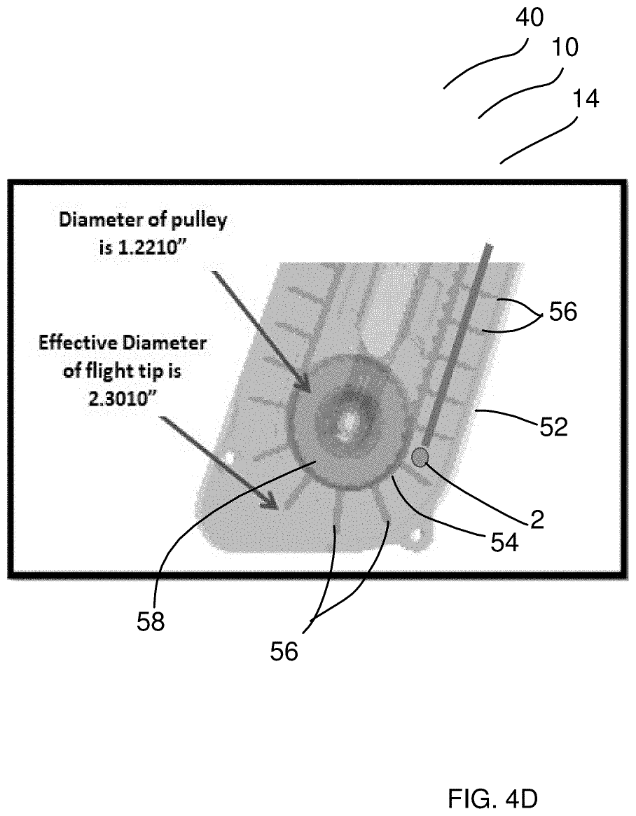

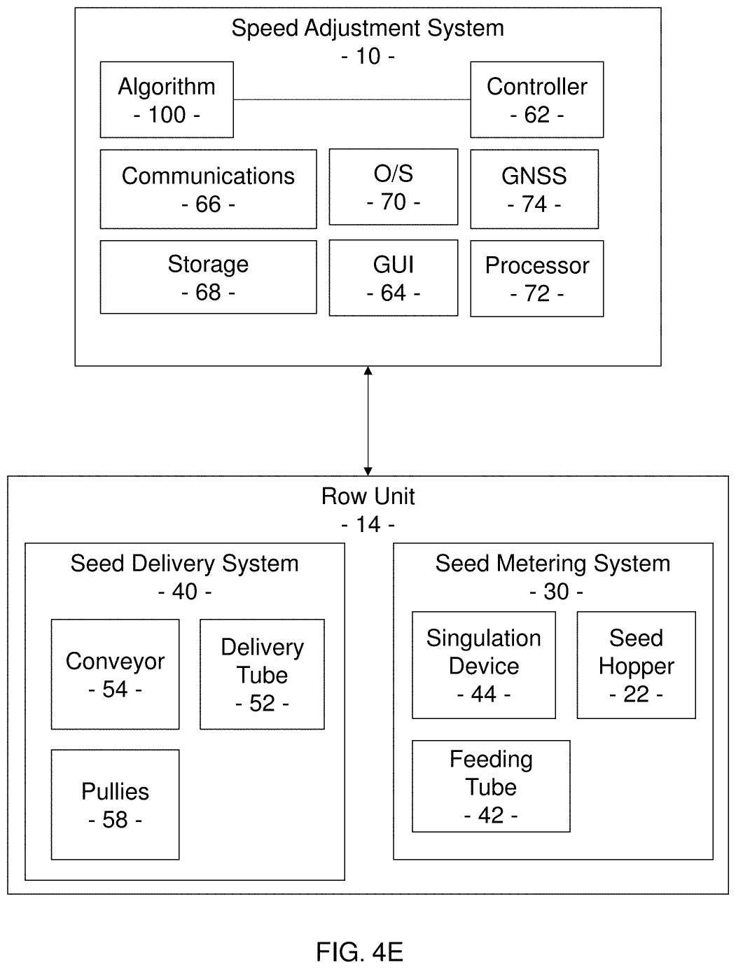

FIG. 4A depicts an exemplary planter or seeding machine that, according to one implementation, can have a speed adjustment system 10 as disclosed or contemplated herein. The planting machine 8 in this specific implementation is a row crop planter 8 having a central crossbar 12 and multiple planting row units 14 mounted to the crossbar 12. It is understood that, generally, the row units 14 on a particular planter (such as exemplary planter 10) are typically identical or substantially similar. The seeding machine 10 moves forward and backward via the fore-aft direction shown by the arrow A.

In various implementations, the planter 8 includes at least one hopper 18 to hold seed. In certain implementations, the planter 8 includes unit hoppers on each planting unit 14 such that seed can be delivered from the hopper 18 to a unit hopper (such as hopper 22 shown in FIG. 4B) on each unit 14. In a further alternative implementation, any known hopper or seed retention device configuration can be incorporated into the planter 8 and the separate row units 14, and function with the seed metering system 30 and speed adjustment system 10 implementations discussed herein.

One example of a row unit 14 having a speed adjustment system 30, according to one implementation, is depicted in greater detail in FIG. 4B. It is understood that any speed adjustment system 10 according to any implementation disclosed or contemplated herein can be incorporated into any known row unit 14 having any configuration. This exemplary row unit 14 is coupled to the central crossbar 12 via a parallelogram linkage 20 made up of two linkage arms 20A, 20B such that the individual row units 14 are vertically moveable relative to the crossbar 12. The exemplary row unit 14 in this implementation has known components, including a hopper 22, gauge wheels 24 (controlling the depth of the furrow), furrow opening disks 26 (to form an open furrow in the soil beneath the seeding machine 8 into which seed is deposited), and a closing and/or packing wheel (or wheels, in this specific example) 28 (to close the furrow over the deposited seed and to firm the soil in the closed furrow), as are generally understood in the art. Alternatively, any similar known components or features can be incorporated into the row units 14.

In this implementation, a seed metering system 30 is disposed on the row unit 14, and more specifically, coupled to, or disposed within, the frame member 32 thereof, such that it can be in operable communication with the hopper 22. The frame member 32 is coupled to the parallelogram linkage 20. Seed is stored or retained in the seed hopper 22 and provided to the seed meter system 30 by any appreciated mechanism.

From the seed meter system 30, the seed is carried by a delivery system 40 into a planting furrow, or trench, formed in the soil by furrow opening disks 26. It is understood that the speed adjustment system 10 implementations, as disclosed or contemplated herein, can be coupled to and operate with any known seed delivery system 40 having a flighted belt or other delivery mechanism having discrete spacing.

A depiction of a seed metering system 30 and seed delivery system 40, according to one embodiment, is shown in FIG. 4C. The seed delivery system 40 may include a seed delivery tube 52 and furrow opening disks 26. It is understood that the various components depicted in FIG. 4C constitute components of a row unit 14. In certain implementations, each row unit (such as row unit 14) on a planting machine 8 can have all of these components. Other row unit 14 configurations are also contemplated herein.

In certain implementations, the row unit 14 and seed metering system 30 includes a seed singulation device 44 operatively engaged with a hopper (shown in FIG. 4B at 22), such that seeds from the hopper 22, or other seed retention device, move through the seed singulation device 44. The seed singulation device 44 operates to isolate or singulate seeds, and such seeds are conveyed in a separate and singular fashion to the delivery tube 52. Various seed singulation devices 44 and systems would be appreciated by those of skill in the art.

FIG. 4D depicts a portion of an exemplary seed delivery system 40 with the disclosed speed adjustment system 10. In various implementations, a delivery tube 52 is provided where a conveyor (also referred to herein as a “flighted belt”) 54 transfers seed 2 from a seed metering system 30 or other seed singulation device 44 to the ground. In these implementations, the conveyor 54 is configured to hold a seed 2 between two projections (also referred to herein as “flights”) 56.

In alternative implementations, the conveyor 54 is any known mechanism for transferring a seed 2 between two points having discretely spaced projections 56. In certain implementations, the conveyor 54 is a flighted belt 54 with discretely spaced flights 56 where a seed 2 can be placed between two flights for travel along the length of the seed delivery tube 52.

In various implementations, the conveyor 54 travels the length of the seed delivery tube 52 such as to transfer seeds 2 from the seed metering system 30 to the ground at specified spacing. In various implementations, the conveyor 54 travels around a set of pullies 58 including lower pully 58 within the seed delivery tube 52. In these implementations, the conveyor 54 travels in a closed loop within the seed delivery tube 52, where a seed is inserted between two flights 56 at a first end and the seed is ejected from the seed delivery tube 52 at a second end.

Turning to FIG. 4E, in various implementations, a speed adjustment system 10 is provided where a processor 60, controller 62, and/or other computing device is constructed and arranged to adjust the speed of the conveyor 54 to increase the consistency of seed spacing while minimizing deviation from planting speed, as will be discussed further herein. In these implementations, the conveyor 54 speed can be adjusted such that the flight 56 spacing substantially matches the target seed spacing, thereby improving the consistency of actual seed spacing on the ground.

In various implementations, the system 10 may include a maximum and minimum deviation from ground speed for the conveyor 54 speed. That is, below a certain percentage of ground speed—too slow—the number of doubles planted may increase, which is not desirable and above a certain number of doubles the beneficial effects of the speed adjustment system 10 would be outweighed. Further, above a certain percentage of ground speed—too fast—seed could be projected out to the trench, causing poor seed spacing that is sought to be remedied by the disclosed system 10. These maximum and minimum deviations or limits may be user entered or determined by the system 10, as would be appreciated.

In various implementations, the speed adjustment system 10 optionally includes a variety of optional components necessary to accomplish the functions described therein. For example, in certain implementations, the speed adjustment system 10 comprises an on-board computer/display, such as the InCommand® display from Ag Leader®. In alternative implementations, the speed adjustment system 10 is optionally disposed on a cloud-based system, and/or comprises both local/display-based components as well as cloud based components, as would be understood.

In various implementations, the speed adjustment system 10 may optionally include a graphical user interface (“GUI”) 64, and optionally a graphics processing unit (“GPU”). In these and other implementations, the GUI 64 and/or GPU allows for the display of information to a user and optionally for a user to interact with the displayed information, as would be readily appreciated. It would be understood that various input methods are possible for user interaction including but not limited to a touch screen, various buttons, a keyboard, or the like, as would be readily appreciated.

Further implementations of the speed adjustment system 10 include a communications component 66. The communications component 66 may be configured for sending and/or receiving communications to and from one or more of vehicles 8, the seed delivery system 40, the cloud system, the seed metering system 30, and/or any components thereof, as would be appreciated. That is, the communications component 66 may comprise one or more of wireless or wired connections to a variety of such components, as would be appreciated.

The speed adjustment system 10, in various implementations, may also include storage 68, an operating system 70, a processor 72, a GNSS unit 74 and various other electronic, hardware, and/or software components necessary to effectuate the various processes and methods described herein.

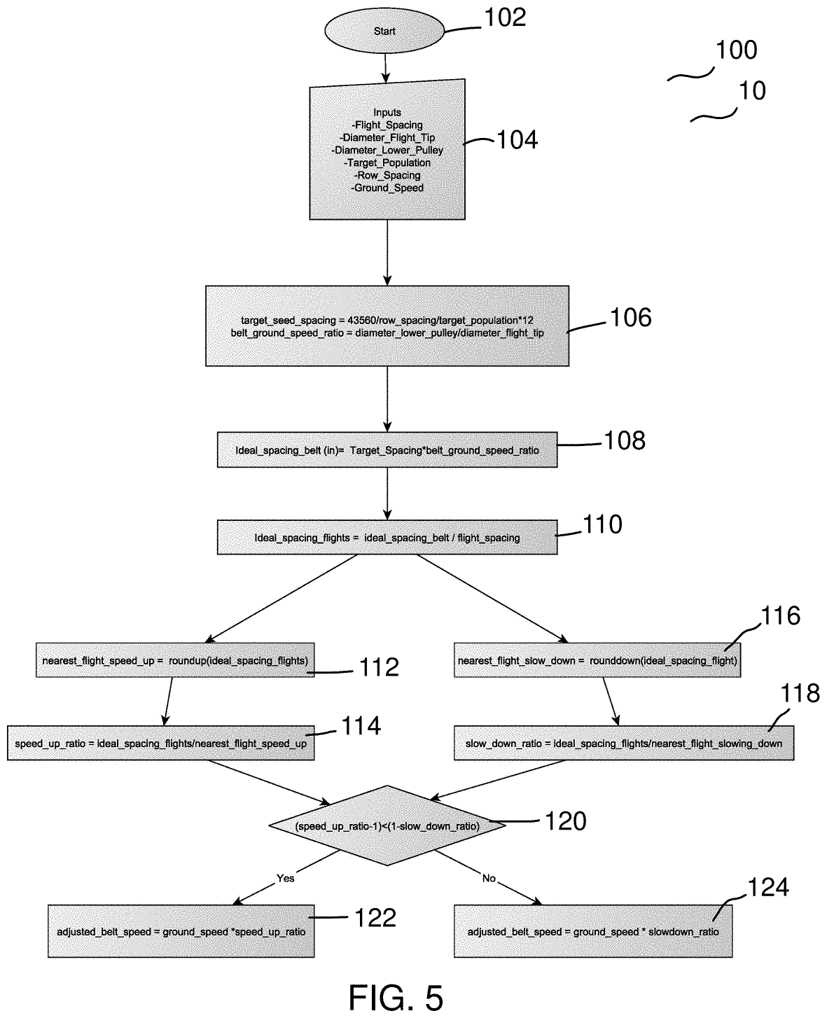

In certain implementations, the controller 62 executes an algorithm 100 in order to substantially match the ground speed to the flighted belt 54 speed to the target seed spacing. FIG. 5 shows an exemplary flow chart of the algorithm 100. The algorithm 100 consists of various steps and sub-steps that can be performed in any order or not at all. In a first step, the controller 62 begins executing the algorithm 100 (box 102).

In an optional step, various inputs are obtained or otherwise determined by the algorithm 100 (box 104). In certain implementations, the inputs can include the flight 56 spacing (the distance between the individual flights 56 on the flighted belt 54), the diameter at the flight 56 tip, the diameter of the lower pulley 58, the target plant population, the row spacing (the distance between row units), the seed spacing (the target distance between the seeds in a crop row), and the ground speed (the speed at which the planter 8 is traveling). In various implementations, the controller may automatically obtain the inputs from the planter 8. In certain alternative implementations, the inputs may be entered by a user prior to or during planting operations. In still further implementations, a combination of manual and automatic entry may be used, as would be appreciated.

In another step, the controller determines the target seed spacing (box 106). Alternatively, the target seed spacing is user entered or otherwise inputted such as from a stored seed spacing value/history. In certain implementations, the algorithm 100 utilizes one or more equations and inputted parameters to determine the target seed spacing (box 106), such as Eq. 1 below.

### Eq. 1.

$$targetseedspacing = ( 43560 \frac{{ft}^{2}}{acre} ) \text{/} ( targetpopulation ) \text{/} rowspacing ( ft ) * \frac{in}{ft}$$

Shown below in Eq. 2 is an exemplary calculation of target seed spacing (box 106) according to an illustrative example. In this example, the target population is 32,000 seeds/acre, the row spacing is 2.5 ft, so it follows that the target seed spacing is 6.534 inches. Various alternative equations and variations thereof would be appreciated by those of skill in the art, such as using metric units.

### Eq. 2:

$$targetseedspacing = ( 4356 \; 0 \frac{{ft}^{2}}{a c r e} ) \text{/} ( 3200 \; 0 \frac{seeds}{acre} ) \text{/} ( 2.5 ft ) * 12 \frac{in}{f t} = 6.5 \; 34 inch$$

In various exemplary implementations, the target seed spacing is not equal to the spacing on the flighted belt 54. This variation between target seed spacing and spacing on the flighted belt 54 can be attributed to the fact that in many known planting systems the speed of the flighted belt 54 within the delivery tube 52 is controlled such that the tip of each flight 56 is traveling at ground speed as it travels around the lower pulley 58 at the bottom of the delivery tube 52, such that the seed is ejected from the delivery tube 52 at substantially the same speed as the travel speed of the planter. It would be understood that the linear speed of the flighted belt 54 will be slower than speed of the flight 56 tip at the bottom of the delivery tube 52 and therefore the seed spacing on the flighted belt 54 will be less than seed spacing on the ground. That is, the linear speed of the conveyor 54 is less than the projection 56 tip speed as the belt 54 paces around the pulley 58 at the distal end of the delivery tube 52 where the seed 2 is ejected.

In these and other implementations, in an optional step, the controller 62 determines the optimal/ideal seed spacing on the flighted belt 54 (box 108) using the ratio of the linear speed of the flighted belt to linear ground speed that is equal to the ratio of pulley diameter to the diameter of the conveyor 54 as measured at the tip of the projections 56, as shown in Eq. 3 below.

### Eq. 3:

$$\frac{{diameter}_{pulley}}{{diameter}_{flighttip}} = \frac{{linearspeed}_{belt}}{{linearspeed}_{ground}} = \frac{{idealflightspacing}_{in}}{targetseedspacing}$$

Continuing with the specific example provided in Eq. 2 above, where the target seed spacing is 6.534 inches and wherein the diameter of the pulley 58 is 1.2210 inches and the effective diameter of the flight tip is 2.3010 inches. In this example the seed spacing on the conveyor, ideal flight spacing, should be 3.46 inches as shown in Eq. 4 below.

idealflightspacing=6.534*(1.2210/2.3010)=3.46 inches Eq. 4:

In a further optional step, the controller determines the optimal/ideal spacing on the flighted belt 54 in flights per seed (box 110). As would be understood, when using a flighted belt spacing of seeds at precise distances is not possible, instead the seeds are placed between flights 56 which are at fixed positions and the seed may be able to move around slightly between the flights 56. A conversion of inches per seed to flights per seed (box 110) is shown in Eq. 5 below.

idealspacing_{flights/seed}=idealflightspacingᵢₙ/flightspacing Eq. 5:

Continuing with the specific example of Eqs. 2 and 4 above. The number of flights 56 between seeds should be 6.19 flights per seed when the ideal flight spacing is 3.46 inches per seed and the distance between flights 56 is 0.559 inches, as shown in Eq. 6 below.

idealspacing_{flights/seed}=3.46/.559=6.19 flights/seed Eq. 6:

As would be appreciated, it is not possible to have a non-whole number of flights 56 between seeds. That is, with the specific example discussed herein, there cannot be 6.19 flights per seed, there can only be a whole number of 6 or 7 flights between seeds.

In various implementations, in another optional step, the controller 62 matches ideal seed spacing (flights per seed) to an integer value. To match the ideal spacing in flights per seed to an integer value the speed of the flighted belt 54 can be increased or decreased. By increasing the speed of the flighted belt 54 the number of flights 56 between each seed will increase. Conversely by decreasing the speed of the flighted belt 54 the number of flights 56 between seeds will decrease.

In various implementations, in an optional step, the controller 62 determines if the flighted belt 56 speed should be increased or decreased via a number of optional steps, described further below. It is understood that each of these steps is optional and may be not performed at all.

In one optional step, the controller 62 determines the nearest flight speed up/nearest larger integer (box 112) by rounding up the ideal spacing in flights per seed value, such as that determined in the previous step of box 110. In a further optional step, the controller 62 determines a ratio of the nearest larger integer to the ideal spacing in flights per seed to determine how much the speed would need to increase for the number of flights per seed to equal the next larger integer (box 114), as shown in Eq. 7. Eq. 7:

$$speedupratio = \frac{nearestlargerinteger}{{idealspacing}_{flights \text{/} seed}}$$

Continuing with the specific example discussed herein, wherein the ideal spacing in flights per seed is 6.19 flights, the nearest larger integer is 7 and the speed up ratio is therefore equal to 1.13, as shown in Eq. 8.

speedupratio=7/6.19=1.13 Eq. 8:

In another optional step, the controller 62 determines the nearest flight slow down/nearest smaller integer (box 116) by rounding down the ideal spacing in flights per seed, such as that determined in the previous step of box 110. In a further optional step, the controller 62 determines a ratio of the nearest, smaller integer to the ideal seed spacing to determine how much the speed would need to decrease for the number of flights per seed to equal the next smaller integer (box 118), as shown in Eq. 9. Eq. 9:

$$slowdownratio = \frac{nearestsmallerinteger}{{idealspacing}_{flights \text{/} seed}}$$

Continuing with the specific example discussed herein, wherein the ideal spacing in flights per seed is 6.19 flights, the nearest smaller integer is 6 and the slow down ratio is therefore equal to 0.969, as shown in Eq. 10.

slowdownratio=6/6.19=0.969 Eq. 10:

It is further appreciated that in high-speed planting it is desirable to eject the seed backwards at the same speed the planter is moving forward. To stay as close to equal speed ejection as possible, the controller 62 may compare the speed up ratio and slow down ratio for their proximity to one (1), such as set forth in Eq. 11 below. Various alternative methods of comparison are possible, would be appreciated by those of skill in the art, and are contemplated herein.

speedupratio−1<1−slowdownratio Eq. 11:

In a further step, the controller 62 compares these values and selects either the slow down ratio or speed up ratio based on which value is closer to 1 (box 120). If the speed up ratio is closer to one than the slow down ratio—Eq. 11 is true—then the controller 62 will cause the flighted belt 54 speed to increase. In various implementations, the increase in flighted belt speed is equal to the ground speed multiplied by the speed up ratio (box 122), as set forth in Eq. 12.

adjustedbeltspeed=groundspeed*speedupratio Eq. 12:

If Eq. 11 is false, such that the slow down ratio is closer to one than the speed up ratio, the controller 62 will cause the flighted belt 54 speed to slow down. It is understood that the decrease in flighted belt 54 speed is equal to the ground speed multiplied by the slow down ratio (box 124), as set forth in Eq. 13.

adjustedbeltspeed=groundspeed*slowdownratio Eq. 13:

In various implementations, the algorithm 100 is run iteratively, such that flighted belt 56 speed can be periodically or continuously adjusted based on ground speed and any other adjustment to the parameters set forth herein.

### EXAMPLES

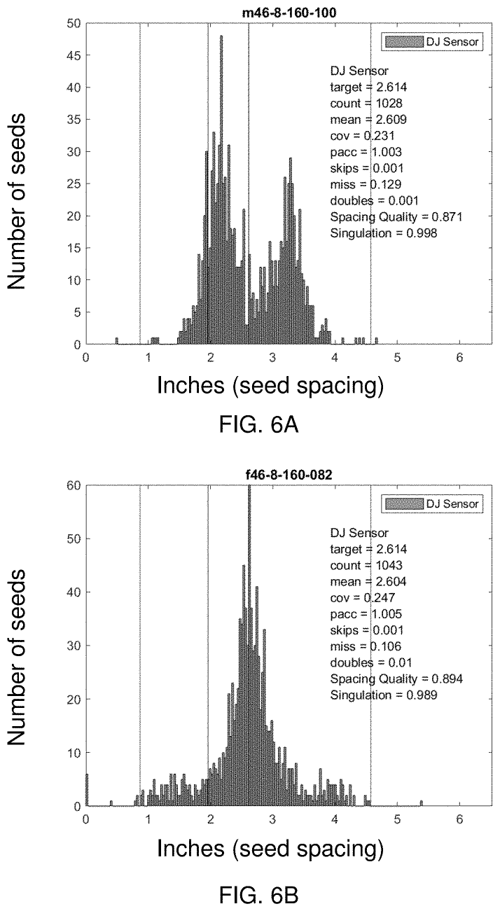

Example 1: FIGS. 6A and 6B show examples of the number of seeds placed at different speed spacings from a soy planter where the row units were spaced 15 inches apart. In this example, the planter utilized a soybean disc with one row of cells for picking up and singulating seeds. FIG. 6A shows the seed placement when no adjustment is provided to the flighted belt and the belt speed set only to match the ground speed. FIG. 6B shows the seed placement when the flighted belt speed is adjusted via the speed adjustment system 10 and algorithm 100, discussed above. As can be seen in comparing FIGS. 6A and 6B with the speed adjustment system 10, as discussed herein, more seeds are placed at the ideal spacing.

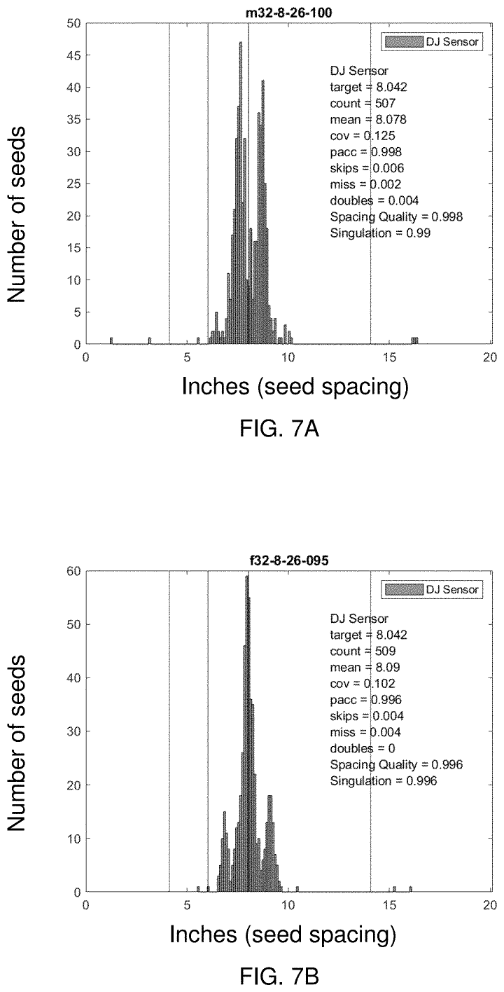

Example 2: FIGS. 7A and 7B shows similar results to Example 1 during corn planting. When controlling the speed of the flighted belt only to match the ground speed two prominent peaks are seen for the placement of seeds, as is shown in FIG. 7A. When planter includes the speed adjustment system 10 and the flighted belt speed is adjusted as discussed herein, there are three peaks, two small and one large, such that more seeds are placed at the target spacing, as is shown in FIG. 7B.

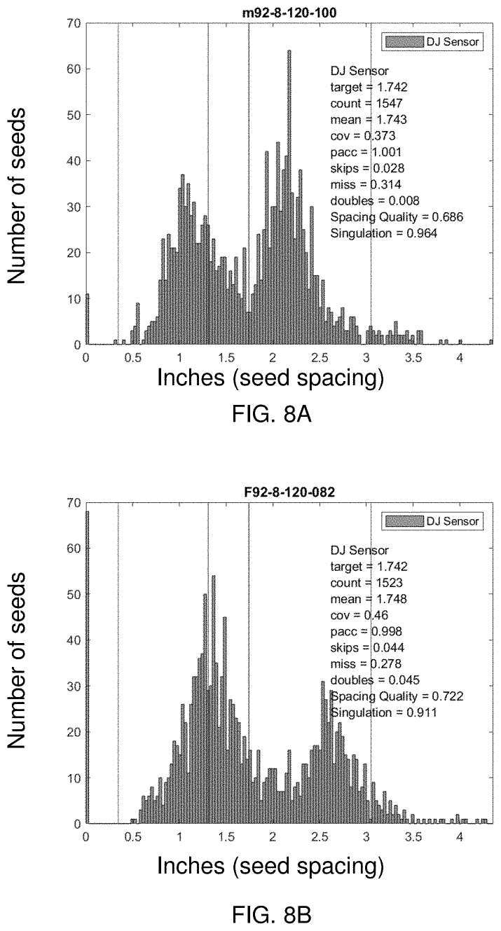

Example 3: FIGS. 8A and 8B show the number of seeds at each seed spacing from a soy planter where the row units were placed 30 inches apart. In this example, the planter utilized a soybean disc with two rows of cells for picking up and singulating seeds. In FIG. 8A no adjustment was made to the belt speed and in FIG. 8B the flighted belt speed was adjusted according to the speed adjustment system 10 and algorithm 100 discussed herein. In this example, the flighted belt speed was slowed down. When slowing down the belt speed there is more time for multiple seeds to populate a single flight, seen by the increase in doubles from FIG. 8A to FIG. 8B. When adjusting the flighted belt speed, the distribution of seed spacing shifted to the right indicting an increase in seed spacing.

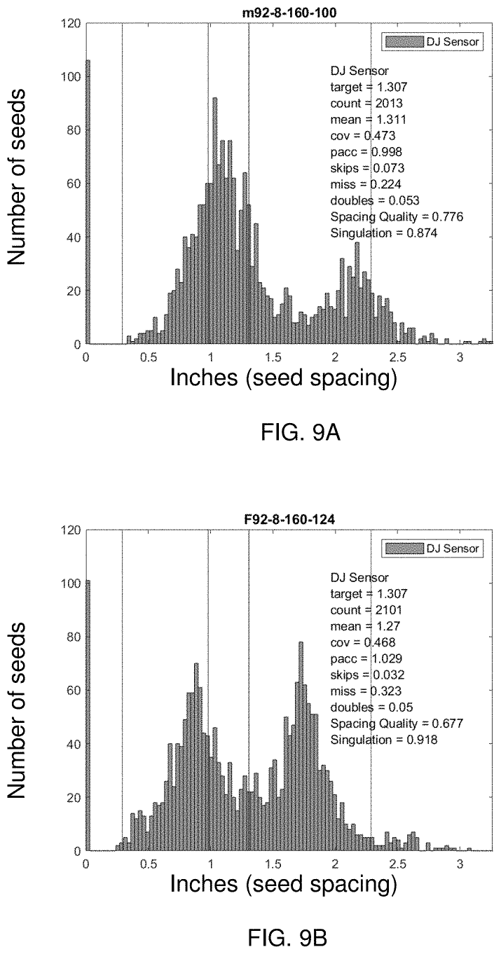

Example 4: FIGS. 9A and 9B show the number of seeds at each seed spacing from a soy planter where the row units were placed 30 inches apart. In this example, the planter utilized a soybean disc with two rows of cells for picking up and singulating seeds. In FIG. 9A no adjustment was made to the belt speed and in FIG. 9B the flighted belt speed was adjusted according to the speed adjustment system 10 and algorithm 100 discussed herein. In this example, the flighted belt speed was increased. When increasing the belt speed the number of multiples and skips decreased. When adjusting the flighted belt speed the distribution of seed spacing shifted to the left indicting an decrease in seed spacing.

Although the disclosure has been described with references to various embodiments, persons skilled in the art will recognized that changes may be made in form and detail without departing from the spirit and scope of this disclosure.

What is claimed is:

1. A method for delivering seeds to a seed trench comprising:
determining an ideal spacing of flights per seed; and
adjusting a speed of a flighted belt such that the ideal spacing of flights per seed is an integer,
wherein the speed of the flighted belt is adjusted such that ejection speed of the seed is approximately equal to ground speed of a planter.

2. The method of claim 1, further comprising determining a nearest larger integer and nearest smaller integer for the ideal spacing of flights per seed.

3. The method of claim 2, further comprising reducing the speed of the flighted belt when the ideal spacing of flights per seed is closer to the nearest smaller integer than the nearest larger integer.

4. The method of claim 3, wherein the reduction of speed of the flighted belt is equal to
$$groundspeed * \frac{nearestsmallerinteger}{{idealspacing}_{flights \text{/} seed}} .$$

5. The method of claim 2, further comprising increasing the speed of the flighted belt when the ideal spacing of flights per seed is closer to the nearest larger integer than the nearest small integer.

6. The method of claim 5, wherein the increase of speed of the flighted belt is equal to
$$groundspeed * \frac{nearestlargerinteger}{{idealspacing}_{flights \text{/} seed}} .$$

7. The method of claim 1, further comprising inputting one or more of a flight tip diameter, a pulley diameter, and a row spacing.

8. The method of claim 7, further comprising determining a ground speed of the planter.

9. The method of claim 8, wherein the ideal number of flights per seed is equal to
$$targetseedspacing * \frac{{diameter}_{pulley}}{{diamter}_{flighttip}} .$$

10. A seed delivery system, comprising:
(a) a seed meter;
(b) a flighted belt configured to accept seed from the seed meter, transport seeds to an ejection location, and eject seeds into a seed trench; and
(c) a controller in communication with the flighted belt configured to control speed of the flighted belt,
wherein the controller is configured to dynamically adjust the speed of the flighted belt.

11. The system of claim 10, wherein the speed of the flighted belt is adjusted as a percentage of ground speed.

12. The system of claim 10, wherein the controller is configured to determine an ideal number of flights per seed.

13. The system of claim 12, wherein the controller compares the ideal number of flights per seed to a next larger integer and a next smaller integer, and wherein the controller adjusts the speed of the flighted belt such that the number of flights per seed is equal to either the next larger integer or the next smaller integer whichever is closer to the ideal number of flights per seed.

14. The system of claim 12, wherein the flighted belt paces around at least one pulley, wherein a ratio of a diameter of the pulley to a diameter at a tip of a flight of the flighted belt multiplied by a target seed spacing is equal to the ideal number of flights per seed.

15. The system of claim 10, wherein the speed of the flighted belt causes the seed to be ejected into the seed trench at approximately forward travel speed of a planter.

16. A method for dynamically adjusted speed of a seed delivery belt, comprising:
receiving by the seed delivery belt seed from a seed meter, the seed delivery belt comprising discretely placed flights; and
adjusting a speed of the seed delivery belt to deliver seeds to a seed trench at a target seed spacing.

17. The method of claim 16, further comprising determining an ideal number of flights per seed.

18. The method of claim 17, further comprising: determining the nearest larger integer to the ideal number of flights per seed, determining the nearest smaller integer to the ideal number of flights per seed, calculating a speed up ratio equal to
$$\frac{nearestlargerinteger}{{idealspacing}_{flights \text{/} seed}} ,$$
calculating a slow down ratio equal to
$$\frac{nearestsmallerinteger}{{idealspacing}_{flights \text{/} seed}} ,$$
determining if the speed up ratio or the slow down ratio is closer to one, and slowing down the seed delivery belt if the slow down ratio is closer to one or speeding up the seed delivery belt if the speed up ratio is closer to one.

19. The method of claim 18, wherein the speed of the seed delivery belt is adjusted to groundspeed*speedupratio if the seed delivery belt is to be sped up and is adjusted to groundspeed*slowdownratio if the seed delivery belt is to be slowed down.

20. The method of claim 19, wherein the method is performed iteratively.
